(19) United States
(12) Patent Application Publication
(10) Pub. No.: US 2007/0024786 A1
(43) Pub. Date: Feb. 1, 2007

(54) Substrate for display device and liquid crystal display device having the same

(75) Inventors: Yoshinori Tanaka, Kanagawa (JP); Kenichi Nagaoka, Kanagawa (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/441,068

(22) Filed: May 26, 2006

(30) Foreign Application Priority Data
May 30, 2005 (JP) 2005-158065

(51) Int. Cl. G02F 1/1343

(52) U.S. Cl. 349/139; 349/38

(57) ABSTRACT

The invention is to provide a substrate for a display device which can easily repair a short circuit defect, and a liquid crystal display device having the same. A substrate for a display device is configured to have a plurality of bus lines which are formed as they intersect with each other on a substrate through an insulating film; a TFT which is formed near the position at which the bus lines intersect with each other; a pixel area provided with a first pixel electrode which is electrically connected to a source electrode of the TFT, a second pixel electrode which is isolated from the first pixel electrode and connected to the source electrode through capacitance, and a space which isolates the first and the second pixel electrodes from each other; and a slit which is formed along the space at the first pixel electrode near the space.

### BACKGROUND OF THE INVENTION

1. Field of the Invention

The present invention relates to a substrate for a display device and a liquid crystal display device having the same.

2. Description of the Related Art

Generally, a thin film transistor (TFT) substrate for use in a liquid crystal display device has a gate bus line and a drain bus line which are formed on a transparent the substrate and intersected with each other through an insulating film. In addition, the TFT substrate has a TFT which is disposed as a switching element at each of intersecting parts of both of the bus lines, and a pixel electrode which is connected to a source electrode of the TFT and applies voltage to liquid crystals. In such an active matrix liquid crystal display device, in recent years, there is a scheme to improve viewing angle characteristics in which a part of a pixel electrode is connected to a source electrode of a TFT by capacitive coupling to provide a plurality of areas having different threshold voltages in a single pixel (a capacitive coupling halftone (HT) method).

FIG. 15 shows the configuration of two pixels on a TFT substrate before for which the capacitive coupling HT method is used. As shown in FIG. 15, each of pixel areas is split into a subpixel A and a subpixel B. The subpixel A is formed with a pixel electrode 116. The pixel electrode 116 is electrically, directly connected to a storage capacitor electrode 119, a control capacitance electrode 125, and a source electrode of a TFT 120 through a contact hole 124. The subpixel B is formed with a pixel electrode 117 which is isolated from the pixel electrode 116 by a space 140. The pixel electrode 117 has an area which overlaps with a control capacitance electrode 125 through a dielectric layer. In that area, the pixel electrode 117, the control capacitance electrode 125, and the dielectric layer between them form control capacitance Cc. The pixel electrode 117 is indirectly connected to the source electrode of the TFT 120 by capacitive coupling through the control capacitance Cc.

The subpixel B has a transmittance-voltage characteristic (T-V characteristic) different from that of the subpixel A. Since a viewer sees as the characteristic of the subpixel A is combined with the characteristic of the subpixel B, the viewing angle characteristic can be improved. Accordingly, a phenomenon called “discolor” can be suppressed in which the color of an image is changed white when a display screen is viewed in the oblique direction.

Patent Document 1: JP-A-2003-156731

Patent Document 2: JP-A-2002-333870

### SUMMARY OF THE INVENTION

In the case of the configuration shown in FIG. 15, the pixel electrodes 116 and 117 are split in units of single pixels. Basically, the pixel electrodes 116 and 117 are electrically isolated through the space 140, and different levels of voltage are applied to the pixel electrodes 116 and 117. However, in patterning in the photolithography process steps, a pattern is left which is caused by dust and dirt, and the pixel electrodes 116 and 117 are sometimes electrically connected to each other through a short circuit part 142 like a pixel on the right side of the drawing. In this case, particularly when a display screen is viewed from the oblique direction, it is visually recognized as only the optical characteristic of the subpixel A, while in the usual cases, it is visually recognized as the optical characteristics of the subpixels A and B are combined. Therefore, the pixel in which the pixel electrodes 116 and 117 are short-circuited with each other has an electrooptic characteristic different from that of the surrounding pixels, and is recognized as a point defect.

Usually, such a short circuit defect is repaired by irradiating a laser beam onto the short circuit part 142 and cutting it. However, as shown in FIG. 15, when wiring layers in different layers (the storage capacitor bus line 118 and the storage capacitor electrode 119) exist as they overlap with the short circuit part 142, laser beam irradiation rather causes an interlayer short circuit, and thus repair is really difficult.

An object of the invention is to provide a substrate for a display device which can easily repair a short circuit defect, and a liquid crystal display device having the same.

The object is achieved by a substrate for a display device including: a plurality of bus lines which is formed on a substrate as they intersect with each other through an insulating film; a thin film transistor which is formed near a position at which the plurality of the bus lines intersect with each other; a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode; and a slit which is formed along the space at the first and/or second pixel electrode near the space.

In the substrate for a display device according to the invention, the slit is extended almost in parallel with a direction in which the space is extended.

In the substrate for a display device according to the invention, it further includes: a conductive layer which is disposed as it overlaps with the space, wherein the slit is disposed near the conductive layer.

In addition, the object is achieved by a substrate for a display device including: a plurality of bus lines which is formed on a substrate as they intersect with each other through an insulating film; a thin film transistor which is formed near a position at which the plurality of the bus lines intersect with each other; a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode; a conductive layer which is disposed as it is superimposed on the first or second pixel electrode; and a slit which is formed along the conductive layer at the first and/or second pixel electrode near the conductive layer.

In the substrate for a display device according to the invention, the slit is extended almost in parallel with a direction in which the conductive layer is extended.

In the substrate for a display device according to the invention, a width of the slit is 4 μm or below.

Furthermore, the object is achieved by a liquid crystal display device including: a pair of substrates which are disposed as they face each other; and liquid crystals which are sealed between the pair of the substrates, wherein a substrate for a display device according to the invention is used for one of the pair of the substrates.

According to the invention, a substrate for a display device which can easily repair a short circuit defect and a liquid crystal display device having the same can be implemented.

### BRIEF DESCRIPTION OF THE DRAWINGS

The teachings of the invention can be readily understood by considering the following detailed description in conjunction with the accompanying drawings, in which:

FIG. 1 is a diagram illustrating the schematic configuration of a liquid crystal display device according to a first embodiment of the invention;

FIG. 2 is a diagram illustrating the configuration of two pixels of a substrate for a display device according to example 1-1 of the first embodiment of the invention;

FIG. 3 is a diagram illustrating the configuration of two pixels of a substrate for a display device according to example 1-2 of the first embodiment of the invention;

FIG. 4 is a diagram illustrating the configuration of two pixels of a substrate for a display device according to example 1-3 of the first embodiment of the invention;

FIG. 5 is a diagram illustrating the configuration of two pixels of a substrate for a display device according to example 1-4 of the first embodiment of the invention;

FIG. 6 is a diagram illustrating the configuration of two pixels of a substrate for a display device according to example 1-5 of the first embodiment of the invention;

FIG. 7 is a diagram illustrating the pixel structure before which is a premise of a second embodiment of the invention;

FIG. 8 is a diagram illustrating the pixel structure before in which pixel electrodes 16 and 17 are short-circuited with each other;

FIG. 9 is a cross section illustrating the configuration of a TFT substrate before;

FIG. 10 is a diagram illustrating the configuration of a single pixel of a substrate for a display device according to example 2-1 of the second embodiment of the invention;

FIG. 11 is a diagram illustrating conditions in which pixel electrodes 16 and 17 are short-circuited with each other through a short circuit part 42 in the pixel structure according to the example 2-1 of the second embodiment of the invention;

FIG. 12 is a diagram illustrating a modified configuration of a single pixel of the substrate for a display device according to the example 2-1 of the second embodiment of the invention;

FIG. 13 is a diagram illustrating the configuration of a single pixel of a substrate for a display device according to example 2-2 of the second embodiment of the invention;

FIG. 14 is a diagram illustrating the configuration of a single pixel of a substrate for a display device according to example 2-3 of the second embodiment of the invention; and

FIG. 15 is a diagram illustrating the configuration of a substrate for a display device before.

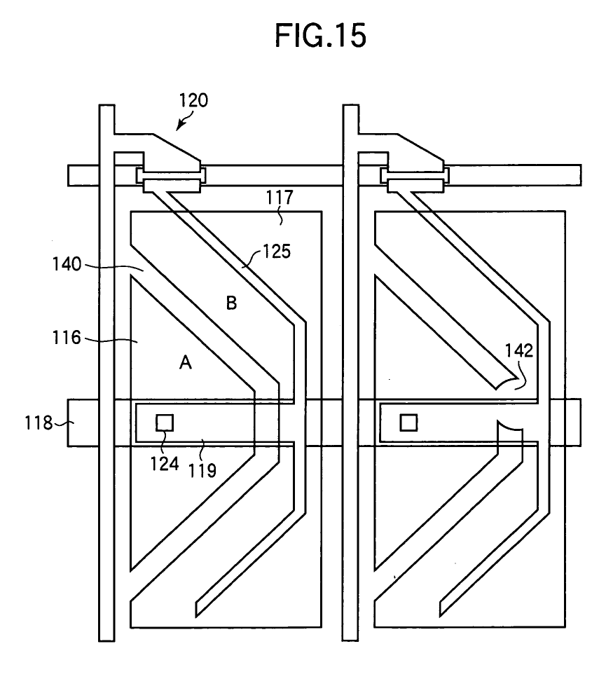

### DESCRIPTION OF THE PREFERRED EMBODIMENT

### First Embodiment

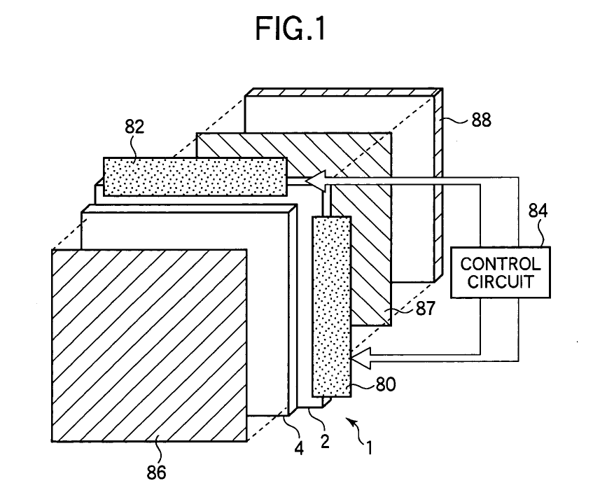

A substrate for a display device and a liquid crystal display device having the same according to a first embodiment of the invention will be described with reference to FIGS. 1 to 6. FIG. 1 shows the schematic configuration of a liquid crystal display device according to this embodiment. As shown in FIG. 1, the liquid crystal display device has a TFT substrate 2 provided with a gate bus line and a drain bus line which are formed as they intersect with each other through an insulating film, and a TFT and a pixel electrode which are formed at every pixel. In addition, the liquid crystal display device has an opposite substrate 4 on which a color filter (CF) and a common electrode, and which is placed as it faces the TFT substrate 2. Between the substrates 2 and 4, liquid crystals are sealed to form a liquid crystal layer (not shown).

To the TFT substrate 2, drive circuits are connected: a gate bus line drive circuit 80 on which a driver IC is mounted to drive a plurality of the gate bus lines, and a drain bus line drive circuit 82 on which a driver IC is mounted to drive a plurality of the drain bus lines. These drive circuits 80 and 82 output a scanning signal and a data signal to a predetermined gate bus line or drain bus line based on a predetermined signal outputted from a control circuit 84. A polarizer 87 is arranged on the surface opposite to the surface of the TFT substrate 2 on which TFT elements are formed, and a polarizer 86 is disposed in crossed Nicol with the polarizer 87 on the surface opposite to the surface of the opposite substrate 4 on which the common electrode is formed. A backlight unit 88 is placed on the surface of the polarizer 87 opposite to the TFT substrate 2.

On the TFT substrate 2, first and second pixel electrodes are formed in every pixel area, which are isolated from each other through a space. The first pixel electrode is electrically connected to a source electrode of the TFT, and the second pixel electrode is indirectly connected to a source electrode of the TFT by capacitive coupling. Near the space at the first and/or second pixel electrode, a slit is formed which is extended along that space. The slit is disposed as it crosses over a lower conductive layer, for example. Thus, even though the first and second pixel electrodes are short-circuited with each other through a short circuit part which overlaps with the lower conductive layer, it can be repaired by laser beam irradiation.

Hereinafter, the substrate for a display device and the liquid crystal display device having the same according to the embodiment will be described more specifically with examples.

### EXAMPLE 1-1

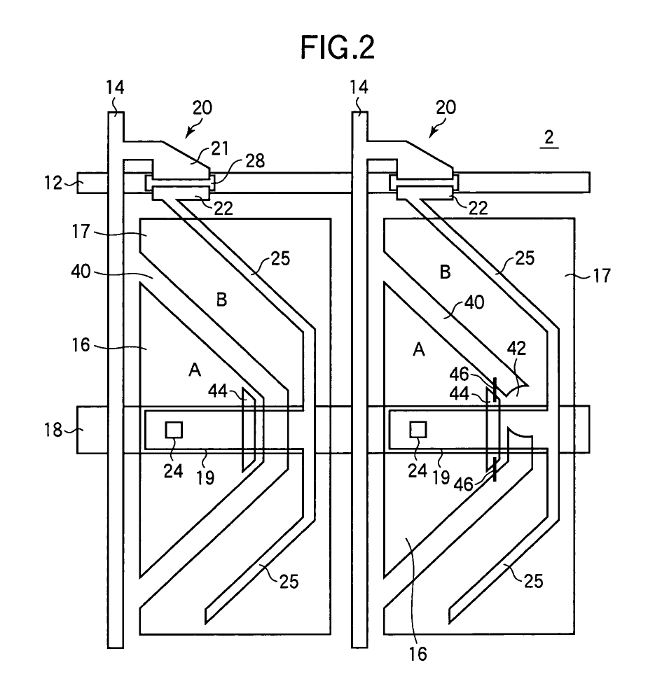

FIG. 2 shows the configuration of two pixels of a TFT substrate 2 according to example 1-1 of the embodiment. As shown in FIG. 2, the TFT substrate 2 has a plurality of gate bus lines 12 which is extended in the lateral direction in the drawing, and a plurality of drain bus lines 14 which is formed as they intersect with the gate bus lines 12 through an insulating film formed of a SiN film etc. and extended in the vertical direction in the drawing. A TFT 20 is formed as a switching element at every pixel, which is disposed near the position at which the gate bus line 12 and the drain bus line 14 intersect with each other. A drain electrode 21 of the TFT 20 is electrically connected to the drain bus line 14. In addition, a part of the gate bus line 12 functions as the gate electrode of the TFT 20. A protective film formed of SiN film etc. is formed over the drain bus line 14 and a drain electrode 21 throughout the surface of the substrate.

In addition, a storage capacitor bus line 18 is formed which is extended in parallel with the gate bus line 12 as it crosses the pixel area defined by the gate bus line 12 and the drain bus line 14. On the storage capacitor bus line 18, a storage capacitor electrode 19 is formed at every pixel through an insulating film. The storage capacitor electrode 19 is electrically connected to a source electrode 22 of the TFT 20 through a control capacitance electrode 25. The storage capacitor bus line 18, the storage capacitor electrode 19 and the insulating film between them form storage capacitance Cs.

The pixel area has a subpixel A and a subpixel B. For example, the subpixel A has a trapezoidal shape, and is placed at the leftward part of the center of the pixel area. The subpixel B is placed at the upper, the lower and the right end of the center in the pixel area except the area for the subpixel A in FIG. 2. The layout of the subpixels A and B is nearly axisymmetric with respect to the storage capacitor bus line 18 in a single pixel. The subpixel A is formed with a pixel electrode 16, and the subpixel B is formed with a pixel electrode 17. For example, the pixel electrodes 16 and 17 are both formed of a transparent conductive film, and formed in the same layer. The pixel electrodes 16 and 17 are isolated from each other through a space 40 where the transparent conductive film is removed. For example, in a liquid crystal display device in VA (vertical alignment) mode, the space 40 also functions as an alignment regulating structure which regulates the alignment of liquid crystals, and the area to form the space 40 is the border between the alignment split areas.

The pixel electrode 16 is electrically connected to the storage capacitor electrode 19, the control capacitance electrode 25 and the source electrode 22 through a contact hole 24 which is opened in the protective film on the storage capacitor electrode 19. On the other hand, the pixel electrode 17 is electrically floated. The pixel electrode 17 has an area which faces the control capacitance electrode 25 through the protective film. The pixel electrode 17, the control capacitance electrode 25 and the protective film between them in that area form control capacitance Cc. The pixel electrode 17 is indirectly connected to the source electrode 22 by capacitive coupling through the control capacitance Cc. In the subpixel A, the pixel electrode 16, a common electrode which is disposed on the opposite substrate 4 as it faces the TFT substrate 2, and a liquid crystal layer which is sealed between the substrates 2 and 4 form liquid crystal capacitance Clc1. In addition, in the subpixel B, the pixel electrode 17, the common electrode, and the liquid crystal layer form liquid crystal capacitance Clc2.

Suppose the TFT 20 is turned to the On state to apply voltage to the pixel electrode 16, and to apply voltage Vpx1 to the liquid crystal layer in the subpixel A. On this occasion, since the potential is split in accordance with the capacitance ratio of the liquid crystal capacitance Clc2 to the control capacitance Cc, voltage different from that applied to the pixel electrode 16 is applied to the pixel electrode 17 in the subpixel B. Voltage Vpx2 applied to the liquid crystal layer in the subpixel B is:
Vpx2=(Cc/(Clc2+Cc))×Vpx1.
Here, 0<(Cc/(Clc2+Cc))<1, and thus it is:
|Vpx1|>|Vpx2|
in the case other than Vpx1=Vpx2=0.
As described above, in the liquid crystal display device according to the embodiment, the voltage Vpx1 applied to the liquid crystal layer in the subpixel A can be varied from the voltage Vpx2 applied to the liquid crystal layer in the subpixel B in a single pixel. Accordingly, the distortion of the T-V characteristic is dispersed in a single pixel, and thus the phenomenon in which the color of an image is discolored when seen from the oblique direction can be suppressed, and the viewing angle characteristic can be improved.

In the embodiment, near the space 40 at the pixel electrode 16, a slit (electrode opening) 44 is formed which is extended along almost in parallel with the space 40. In addition, the space 40 is placed as it partially overlaps with the storage capacitor electrode 19 and the storage capacitor bus line 18, which are the conductive layer. The slit 44 is extended almost vertically to the direction in which the storage capacitor electrode 19 and the storage capacitor bus line 18 are extended, and it is disposed as it crosses over the storage capacitor electrode 19 and the storage capacitor bus line 18. The both ends of the slit 44 do not overlap with the other conductive layers. Desirably, the width of the slit 44 is equal to or below 4 μm in order to suppress liquid crystals alignment irregularities. The width of the slit 44 is formed equal to or below 4 μm, and thus a reduction in the transmittance caused by the slit 44 hardly occurs.

Here, this case is considered as in the pixel on the right side in the drawing, in which the short circuit part 42 is formed as it overlaps with the storage capacitor electrode 19 and the storage capacitor bus line 18 and the pixel electrodes 16 and 17 are short-circuited with each other through the short circuit part 42. In this case, for example, a laser beam is irradiated onto two cutting parts 46 which are near the both ends of the slit 44 and do not overlap with the other conductive layers to cut them to isolate the pixel electrode 16 which is located outside the slit 44. Accordingly, the pixel electrodes 16 and 17 are isolated with no short circuit with the other conductive layers, and thus a short circuit defect is repaired.

### EXAMPLE 1-2

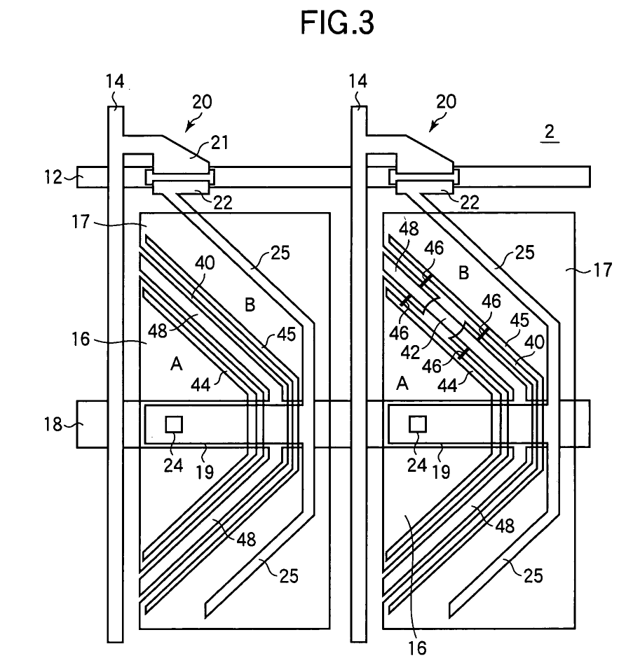

FIG. 3 shows the configuration of two pixels of a TFT substrate 2 according to example 1-2 of the embodiment. As shown in FIG. 3, in this example, a lead electrode 48 is formed which is drawn from the storage capacitor bus line 18 and overlaps with the space 40. The width of the lead electrode 48 is narrower than the width of the space 40, and does not overlap with the pixel electrodes 16 and 17. The lead electrode 48 is maintained to have the same potential as that of the common electrode on the opposite substrate side. Therefore, since no voltage is applied to the liquid crystal layer in the area to form the lead electrode 48, in a liquid crystals display device in the VA mode, for example, liquid crystals molecules in that area are always aligned vertically with respect to the substrate surface. The space 40 to be the border between the alignment split areas is disposed to overlap with the lead electrode 48, and thus the alignment of liquid crystals near the area to form the space 40 is stabilized.

In the example, the pixel electrode 16 is provided with a slit 44, and the pixel electrode 17 is provided with a slit 45. The slits 44 and 45 are crossed over the storage capacitor electrode 19 and the storage capacitor bus line 18, and extended along the space 40 and the lead electrode 48.

This case is considered as in the pixel on the right side in the drawing, in which a short circuit part 42 is formed as it overlaps with the lead electrode 48 and the pixel electrodes 16 and 17 are short-circuited with each other through the short circuit part 42. In this case, for example, a laser beam is irradiated onto four cutting part 46 which do not overlap with the other conductive layers to cut them, and the pixel electrodes 16 and 17 outside the slits 44 and 45 are isolated to electrically separate the short circuit part 42. Accordingly, the pixel electrodes 16 and 17 are isolated with no interlayer short circuit with the other conductive layers, and the short circuit defect is repaired.

### EXAMPLE 1-3

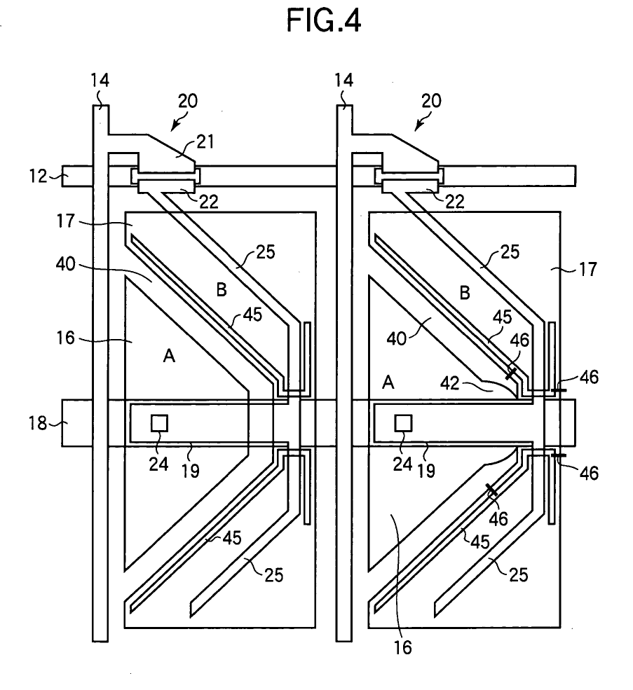

FIG. 4 shows the configuration of two pixels of a TFT substrate 2 according to example 1-3 of the embodiment. As shown in FIG. 4, in the example, a slit 45 is formed at two places above and below the pixel area of a pixel electrode 17 in a subpixel B. The slit 45 is crossed over a control capacitance electrode 25 which is disposed to overlap with the pixel electrode 17, and the slit 45 is extended along almost in parallel with the end of a pixel electrode 17 (space 40) and a storage capacitor bus line 18 (storage capacitor electrode 19) which is disposed to overlap with the pixel electrodes 16 and 17.

This case is considered as in the pixel on the right side in the drawing, in which a relatively great short circuit part 42 is formed as it overlaps with the storage capacitor electrode 19 and the storage capacitor bus line 18, and the pixel electrodes 16 and 17 are short-circuited with each other through the short circuit part 42. In this case, for example, a laser beam is irradiated onto four cutting parts 46 which do not overlap with the other conductive layers to cut them, and the area near the short circuit part 42 is isolated from the pixel electrode 17. Accordingly, the pixel electrodes 16 and 17 are isolated with no interlayer short circuit with the other conductive layers, and the short circuit defect is repaired. In the example, the pixel electrode 17 is isolated into two parts above and below the pixel area. However, the two isolated pixel electrodes 17 both overlap with the control capacitance electrode 25, and are connected to a source electrode 22 of a TFT 20 through a predetermined control capacitance, and thus no problem arises.

### EXAMPLE 1-4

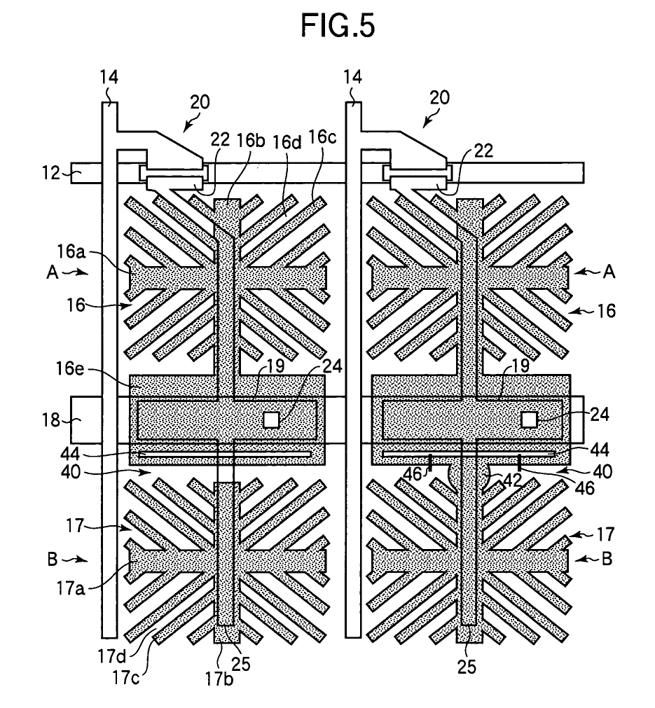

FIG. 5 shows the configuration of two pixels of a TFT substrate 2 according to example 1-4 of the embodiment. As shown in FIG. 5, in the example, a subpixel A is the upper part above a storage capacitor bus line 18 (and near the storage capacitor bus line 18) in the pixel area, and a subpixel B is the lower part below the storage capacitor bus line 18. The subpixel A is formed with a pixel electrode 16 which is electrically connected to a source electrode 22 of a TFT 20, the pixel electrode 16 having a line electrode 16a which is extended almost in parallel with a gate bus line 12, and a line electrode 16b which intersects almost vertically with the line electrode 16a in a cross shape and is extended almost in parallel with a drain bus line 14. In addition, the pixel electrode 16 has a plurality of line electrodes 16c which is obliquely branched from the line electrode 16a or 16b and extended in stripes in the four nearly orthogonal directions in a single pixel, and a micro slit 16d which is formed between the adjacent line electrodes 16c. The pixel electrode 16 further has a solid electrode 16e formed in the vicinity of the storage capacitor bus line 18. Near a space 40 at the pixel electrode 16 (solid electrode 16e), a slit 44 is formed which crosses over a control capacitance electrode 25 and extended along almost in parallel with the storage capacitor bus line 18 which overlaps with the pixel electrode 16 and the space 40.

The subpixel B is formed with a pixel electrode 17 which is isolated from the pixel electrode 16 through the space 40 and connected to the source electrode 22 of the TFT 20 through control capacitance. The pixel electrode 17 has a line electrode 17a which is extended almost in parallel with the gate bus line 12, and a line electrode 17b which intersects with the line electrode 17a at a substantially right angle and is extended almost in parallel with the drain bus line 14. In addition, the pixel electrode 17 has a plurality of line electrodes 17c which is obliquely branched from the line electrode 17a or 17b and extended in stripes in the four nearly orthogonal directions in a single pixel, and a micro slit 17d which is formed between the adjacent line electrodes 17c.

This case is considered as the pixel on the right side in the drawing, in which a short circuit part 42 is formed as it overlaps with the control capacitance electrode 25, and the pixel electrodes 16 and 17 are short-circuited with each other through the short circuit part 42. In this case, for example, a laser beam is irradiated onto two cutting parts 46 which do not overlap with the other conductive layers to cut them, and the area near the short circuit part 42 is isolated from the pixel electrode 16. Accordingly, the pixel electrodes 16 and 17 are isolated with no interlayer short circuit with the other conductive layers, and the short circuit defect is repaired.

### EXAMPLE 1-5

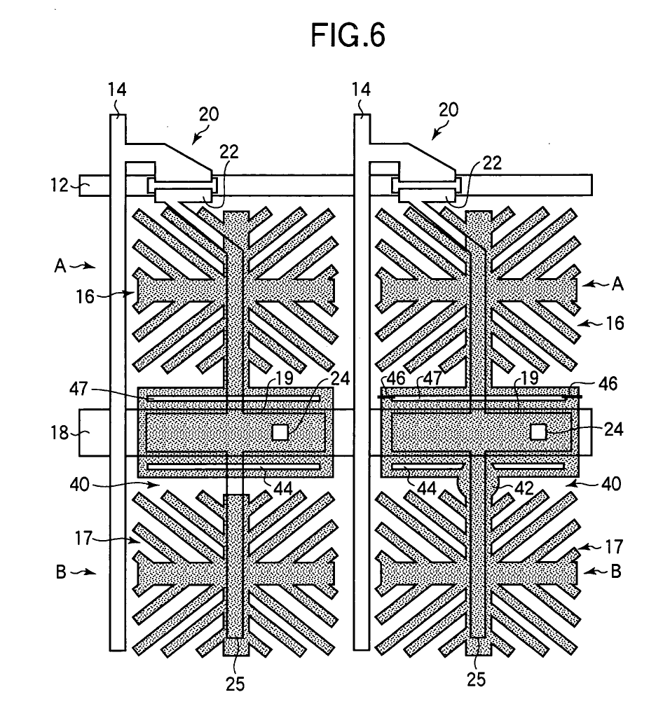

FIG. 6 shows the configuration of two pixels of a TFT substrate 2 according to example 1-5 of the embodiment. As shown in FIG. 6, in the example, two slits 44 and 47 are formed in a solid electrode 16e. The slit 44 is disposed below a storage capacitor bus line 18 which is placed as it overlaps with a pixel electrode 16 in the drawing, and the slit is extended along almost in parallel with the storage capacitor bus line 18. The slit 47 is disposed above the storage capacitor bus line 18 in the drawing, and extended along almost in parallel with the storage capacitor bus line 18. The slits 44 and 47 both cross over a control capacitance electrode 25.

This case is considered as the pixel on the right side in the drawing, in which a relatively great short circuit part 42 is formed as it overlaps with the control capacitance electrode 25 and crosses over the slit 44, the pixel electrodes 16 and 17 are short-circuited with each other through the short circuit part 42. In this case, even though the pixel electrode 16 is cut at the same position as that in the example 1-4, the pixel electrodes 16 and 17 cannot be isolated from each other. Therefore in this case, a laser beam is irradiated onto two cutting parts 46 which are near the both ends of the slit 47 and do not overlap with the other conductive layers to cut them. Accordingly, the pixel electrodes 16 and 17 are isolated from each other with no interlayer short circuit with the other conductive layers, and the short circuit defect is repaired. However, the solid electrode 16e is isolated from the pixel electrode 16, and connected to the pixel electrode 17. Thus, in this pixel, the pixel electrode 17 is electrically connected to a source electrode 22 of a TFT 20, and the pixel electrode 16 is connected to a source electrode 22 through control capacitance.

As described above, according to the embodiment, in the liquid crystal display device using the capacitive coupling HT method, even though a short circuit occurs between the pixel electrodes 16 and 17 by the short circuit part 42 which is formed to overlap with the conductive layer, a short circuit defect can be repaired easily with no interlayer short circuit. Accordingly, a liquid crystal display device of high quality can be fabricated at a high fabrication yield.

### Second Embodiment

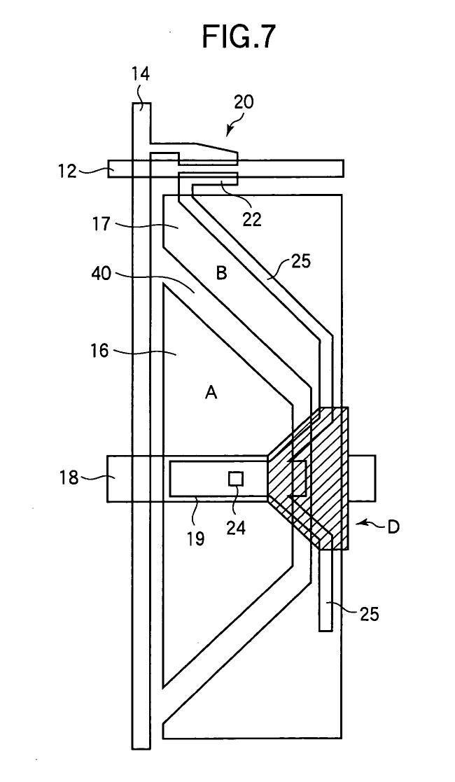

Next, a substrate for a display device and a liquid crystal display device having the same according to a second embodiment of the invention will be described with reference to FIGS. 7 to 14. FIG. 7 shows the pixel structure before using the capacitive coupling HT method, which is a premise of this embodiment. As shown in FIG. 7, a pixel area has a subpixel A and a subpixel B. The subpixel A is formed with a pixel electrode 16, and the subpixel B is formed with a pixel electrode 17. The pixel electrode 16 is electrically, directly connected to a source electrode 22 of a TFT 20. On the other hand, the pixel electrode 17 is indirectly connected to the source electrode 22 by capacitive coupling. The pixel electrodes 16 and 17 are isolated from each other through a space 40. The width of the space 40 is about 10 μm. The pixel electrodes 16 and 17 are isolated from each other, and thus the voltage Vpx1 applied to a liquid crystal layer of the subpixel A can be varied from the voltage Vpx2 applied to a liquid crystal layer of the subpixel B in a single pixel. Therefore, the gray level viewing angle characteristic is improved, and display quality is enhanced.

However, when a problem in fabrication process steps causes a pattern defect in the pixel electrodes 16 and 17, the pixel electrodes 16 and 17 in the same pixel are sometimes short-circuited with each other. In the pixel in which a short circuit occurs, the pixel electrodes 16 and 17 are both electrically, directly connected to the source electrode 22, and the voltage applied to the liquid crystal layer is the same in the entire pixel. Therefore, since the optical characteristic of this pixel is different from that of the other pixels, the pixel is visually recognized as a point defect. Since an increase in capacitance caused by this short circuit is small, in consideration of the detection accuracy of an inspection unit, it is really difficult to detect a place where a short circuit occurs in array inspection. This phenomenon will be described in detail. The detection principle of the defective pixel by the array inspection unit is in which TFTs on the TFT substrate are first in turn turned to the On state and a predetermined level of voltage is applied to the pixel electrode 16 of each of the pixels. Thus, predetermined electric charge is charged in the storage capacitance of each of the pixels. The electric charge is maintained for a predetermined time period, and then the TFTs are again turned to the On state to measure the electric charge charged in each of the pixels. Overcharge and undercharge are determined at a certain slice level with respect to the amount of the electric charge charged in a normal pixel to detect a defective pixel.

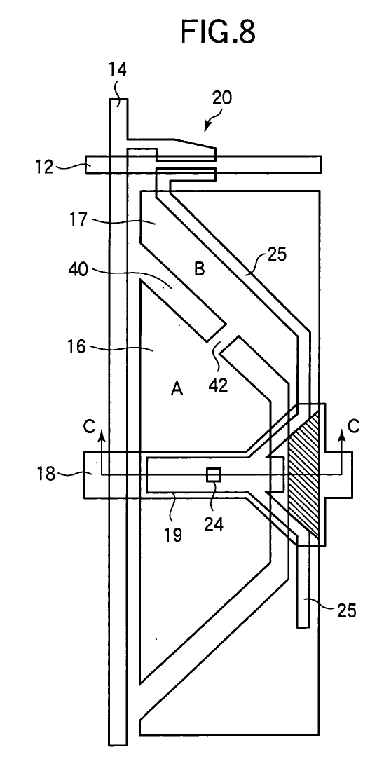

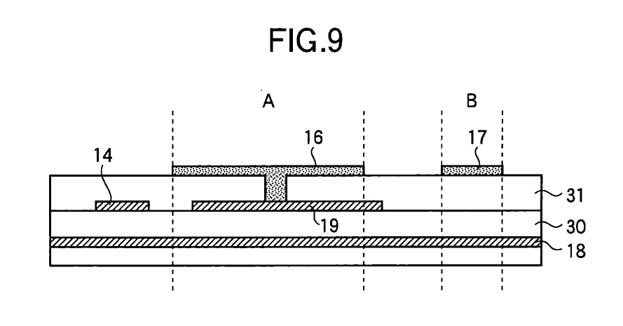

FIG. 8 shows the pixel structure in which the pixel electrodes 16 and 17 are short-circuited with each other through a short circuit part 42. FIG. 9 shows the sectional configuration of a TFT substrate sectioned at line C-C shown in FIG. 8. When the pixel electrodes 16 and 17 are short-circuited with each other, the storage capacitance is increased by the amount of capacitance formed in the area where the storage capacitor bus line 18 and the pixel electrode 17 overlap with each other through an insulating film 30 and a protective film 31 (indicated by back-slash hatching sloping down to the right in FIG. 8), and the amount of the electric charge to be charged is increased. Since the capacitance formed in this area is significantly small because it has a narrow electrode area and a wide space between the electrodes. As compared with the capacitance of the normal pixel, an increase in the capacitance of a defective pixel is about 10%. It is difficult to detect this capacitance difference by the array inspection unit because there are noise fluctuations etc. in wirings. Therefore, there is a problem that it is really difficult to specify a pixel in which the pixel electrodes 16 and 17 are short-circuited with each other in array inspection.

In addition, an area D in a trapezoidal shape in which the storage capacitor bus line 18 is formed to have a wide width (indicated by forward-slash hatching sloping down to the left in FIG. 7) is a significantly important area, and it cannot be changed easily once design is decided. The following is three reasons for this. The first reason is that the area D has areas to form the capacitance of the subpixel A and the capacitance of the subpixel B. When the design for this part is changed, the balance of capacitance is not kept between the subpixels A and B. The second reason is that the area D needs to have a predetermined area or greater because the area D is disposed with piller spacers which maintain a cell gap. The third reason is that the area D is the important area to determine the alignment of liquid crystals because the area D has the potential of the subpixel A and the potential of the subpixel B as well as the piller spacers on the opposite substrate side. From these reasons, the design of the area D cannot be changed easily.

As described above, the liquid crystal display device using the capacitive coupling HT method before has a problem that short circuit detection is really difficult because the capacitance change is small even though the pixel electrodes 16 and 17 are short-circuited with each other. In addition, in the liquid crystal display device using the capacitive coupling HT method before, there is a constraint that the design of the area D cannot be changed easily.

An object of this embodiment is to provide a substrate for a display device which can easily detect a short circuit between the pixel electrodes 16 and 17, and a liquid crystal display device having the same.

The object is achieved by a substrate for a display device including: a gate bus line which is formed on a substrate; a drain bus line which is formed as it intersects with the gate bus line through an insulating film; a storage capacitor bus line which is formed in parallel with the gate bus line; a thin film transistor which is formed near a position at which the gate bus line and the drain bus line intersect with each other; a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode; and a lead electrode which is drawn from the storage capacitor bus line, and which forms superimposed capacitance between it and the second pixel electrode.

In the substrate for a display device according to the embodiment, the lead electrode is extended as it overlaps with the space.

In the substrate for a display device according to the embodiment, the lead electrode has a projection which is disposed as it overlaps with the second pixel electrode.

In the substrate for a display device according to the embodiment, it further includes: a control capacitance electrode which is electrically connected to the source electrode, and which forms capacitance between it and the second pixel electrode; and a second lead electrode which is drawn from the storage capacitor bus line and disposed as it overlaps with the control capacitance electrode, and which forms capacitance between it and the control capacitance electrode.

In addition, the object is achieved by a liquid crystal display device including: a pair of substrates which are disposed as they face each other; and liquid crystals which are sealed between the pair of the substrates, wherein a substrate for a display device according to this embodiment is used for one of the pair of the substrates.

In the liquid crystal display device according to the embodiment, it further includes: a black matrix which is formed on one of the pair of the substrates, and which shields light around the pixel area, wherein at least a part of the lead electrode is disposed in an area in which light is shielded by the black matrix.

In the liquid crystal display device according to the embodiment, it further includes: an alignment regulating structure which is formed on at least one of the pair of the substrates, and which regulates alignment of the liquid crystals, wherein at least a part of the lead electrode is disposed as it overlaps with the alignment regulating structure.

According to the embodiment, a substrate for a display device which can easily detect the short circuit between the pixel electrodes 16 and 17, and a liquid crystal display device having the same can be implemented.

### EXAMPLE 2-1

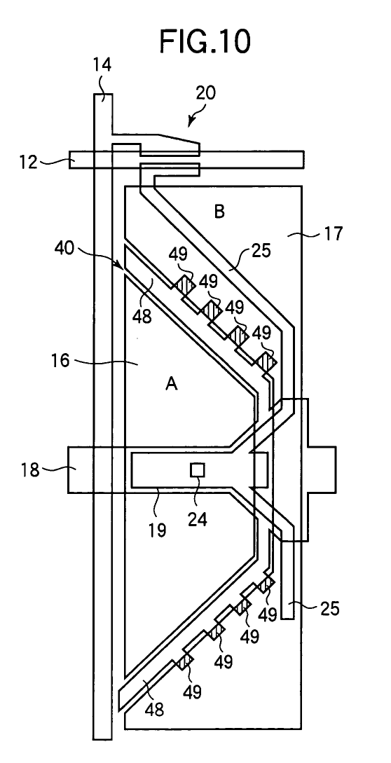

FIG. 10 shows the single pixel configuration of a TFT substrate according to example 2-1 of the embodiment. As shown in FIG. 10, in the example, a lead electrode 48 is formed which is drawn from a storage capacitor bus line 18 and maintained to have the same potential as that of the storage capacitor bus line 18. The lead electrode 48 overlaps with a space 40 between pixel electrodes 16 and 17 and is extended obliquely with respect to the end of the pixel forming area. The lead electrode 48 is placed as it overlaps with an alignment regulating structure such as the space 40, and thus a substantial reduction in the aperture ratio of the pixel can be suppressed. The lead electrode 48 has a plurality of projections 49 formed in comb teeth which is projected toward the pixel electrode 17 side in the substrate surface and disposed as it overlaps with the pixel electrode 17. Between the projection 49 and the pixel electrode 17, capacitance (superimposed capacitance) is formed. Therefore, capacitance is formed between the pixel electrode 17 and the storage capacitor bus line 18 without changing the design of the area D shown in FIG. 7. In addition, the provision of the lead electrode 48 as it overlaps with the space 40 forms capacitance between a short circuit part and the lead electrode 48 when the pixel electrodes 16 and 17 are short-circuited with each other by the short circuit part caused by a pattern defect in the transparent electrode. Thus, it serves advantageously in array inspection.

The area of the projection 49 overlapping with the pixel electrode 17 (indicated by vertical hatching in FIG. 10) is adjusted in consideration of the capacitance ratio of the subpixels A and B. In addition, it may be possible to control capacitance formed in the overlapping area by changing the film thickness of a final protective film 31 as well as the area.

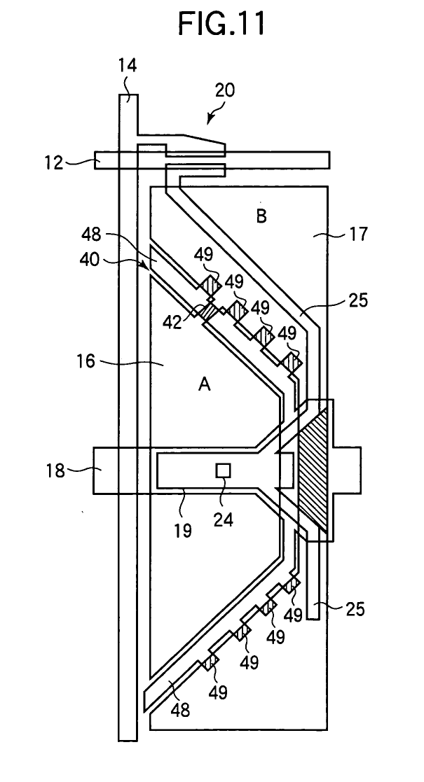

FIG. 11 shows the state in which the pixel electrodes 16 and 17 in the same pixel are short-circuited with each other through a short circuit part 42 formed by a pattern defect in the transparent electrode in the pixel structure of this example. In this state, capacitance C3 is formed in the area of the short circuit part 42 overlapping with the lead electrode 48 (indicated by forward-slash hatching in FIG. 11). In addition, since the pixel electrode 17 has the same potential as that of the pixel electrode 16, an increase in capacitance is C2 which is formed in the area of the pixel electrode 17 overlapping with the storage capacitor bus line 18 (indicated by back-slash hatching in FIG. 11). Furthermore, capacitance is C1 which is formed between the projection 49 and the pixel electrode 17. In the pixel structure before, the capacitance of the pixel in which the pixel electrodes 16 and 17 are short-circuited with each other is increased by C2 more than the normal pixel, whereas in the example, the capacitance of the pixel in which the pixel electrodes 16 and 17 are short-circuited with each other through the short circuit part 42 is increased by C1+C2+C3 more than the normal pixel. More specifically, according to the example, the capacitance change in the pixel in which the pixel electrodes 16 and 17 are short-circuited with each other is increased by C1+C3 more than the pixel structure before. Therefore, it becomes easy to detect a defect in array inspection, and a laser beam is irradiated onto the short circuit part 42 to allow easy repair.

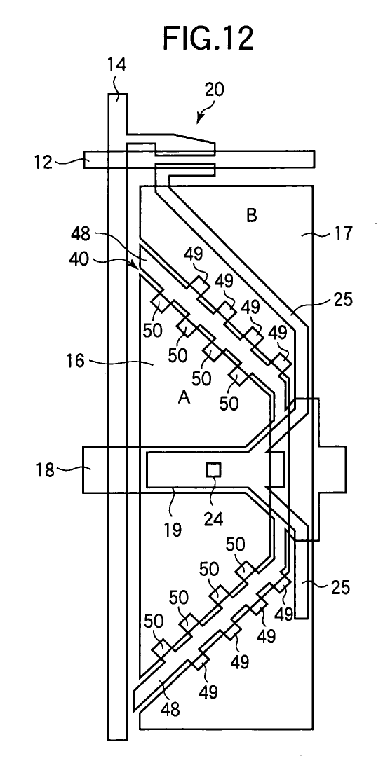

FIG. 12 shows a modification of the configuration of the TFT substrate according to the example. As shown in FIG. 12, in the modification, a lead electrode 48 further has projections 50 which are further projected toward the pixel electrode 16 side in a subpixel A. In the area of the projection 50 overlapping with a pixel electrode 16, predetermined capacitance is formed. The projection 50 is disposed in consideration of the capacitance balance between the subpixels A and B. As described above, the projections 49 and 50 can be formed in comb teeth.

Desirably, the projections 49 and 50 are disposed alternately as shown in FIG. 12. This is because it is necessary to secure the area where a laser beam is irradiated onto a short circuit part 42 to cut it when the pixel electrodes 16 and 17 are short-circuited with each other. More specifically, when a short circuit part 42 is formed at the same position as in FIG. 11, it is difficult to cut the short circuit part 42 on the subpixel A side from the lead electrode 48 because the projections 50 are formed toward the subpixel A side in the modification. This is because the projection 50 and the pixel electrode 16 can have an interlayer short circuit by laser beam irradiation. Therefore, in this case, the short circuit part 42 is cut in the area on the subpixel B side where the projections 49 are not formed, and a defect is repaired.

In array inspection, the potential of the storage capacitor bus line 18 is usually maintained at ground or 0 V. However, in the case of dependence on the capacitance of the storage capacitor bus line 18, a comparison may be made between the pixel capacitance when the potential of the storage capacitor bus line 18 is maintained at normal 0 V and the pixel capacitance when pulse voltage or DC voltage is applied to the storage capacitor bus line 18. The pixel in which a noticeable difference exists in the pixel capacitance has a short circuit between the pixel electrodes 16 and 17. As described above, a predetermined level of voltage is applied to the storage capacitor bus line 18 in array inspection, and thus the difference in the pixel capacitance becomes evident to facilitate specifying a defective pixel.

### EXAMPLE 2-2

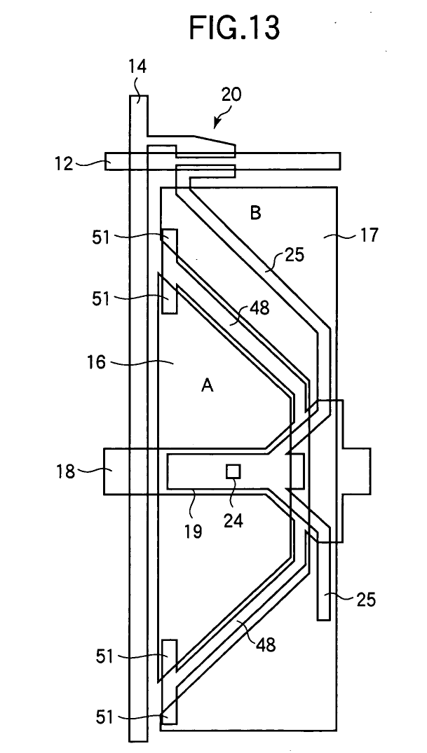

FIG. 13 shows the single pixel configuration of a TFT substrate according to example 2-2 of the embodiment. A storage capacitor bus line 18, a lead electrode 48, projections 49 and 50, etc. are formed of a metal film having light shielding properties. Therefore, when these are used to form capacitance in the pixel area, a problem can arise that the aperture ratio of a pixel is reduced to decrease the panel transmittance. In order to solve this problem, in the example, as shown in FIG. 13, a projection 51 which forms capacitance C1 between pixel electrodes 16 and 17 is disposed in the light shielding area in which light is shielded by a black matrix (BM) formed on the opposite substrate side, for example, in order to block light around the pixel area. After the TFT substrate is bonded to the opposite substrate, the projection 51 is disposed as it overlaps with the BM. As described above, capacitance is formed by overlapping the projection 51 with the pixel electrodes 16 and 17 in the area where the BM basically needs to block light, and thus a reduction in the panel transmittance can be prevented.

### EXAMPLE 2-3

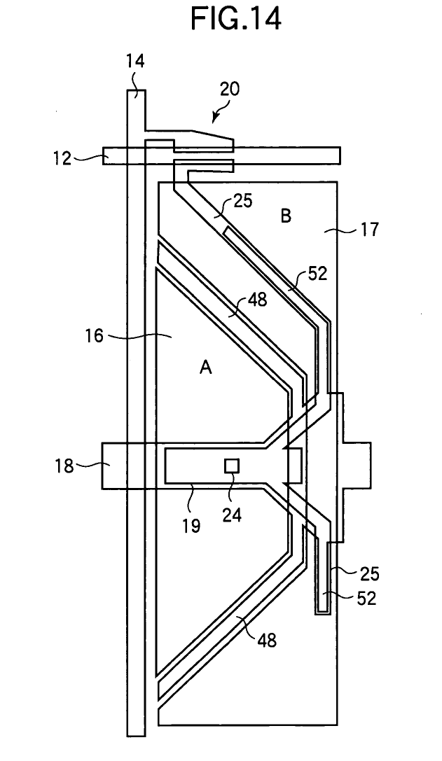

FIG. 14 shows the single pixel configuration of a TFT substrate according to example 2-3 of the embodiment. As shown in FIG. 14, in the example, a second lead electrode 52 is formed which is drawn from a storage capacitor bus line 18. The lead electrode 52 is disposed in the area where light is basically shielded by a control capacitance electrode 25 in the same layer as a drain bus line 14, and is extended along the control capacitance electrode 25. Capacitance is formed between the lead electrode 52 and the control capacitance electrode 25 (source electrode). As described above, the lead electrode 52 is disposed in the area where light is basically shielded, and thus a reduction in the panel transmittance can be prevented. In addition to this, when the pixel electrodes 16 and 17 are short-circuited with each other, capacitance is formed between the storage capacitor bus line forming layer and the drain layer. Thus, the capacitance difference becomes more noticeable than the case in which capacitance is formed between the storage capacitor bus line forming layer and the pixel electrode forming layer.

As described above, according to the embodiment, the capacitance difference generated between the pixel in which the pixel electrodes 16 and 17 are short-circuited with each other and the normal pixel can be made greater. Therefore, a place of a defect can be detected easily in array inspection, and a laser beam is irradiated onto the short circuit part 42 to cut it to repair the defect. Accordingly, a liquid crystal display device of high quality can be fabricated at a high yield. In addition, in the embodiment, it is unnecessary to change the configuration of the area D which is important in the pixel design (see FIG. 7).

The invention is not limited to the embodiments, which can be modified variously.

For example, the liquid crystal display device in the VA mode is taken as an example in the embodiments, but the invention is not limited thereto, which can also be adapted to the other liquid crystal display devices such as one in the TN mode etc.

In addition, in the embodiments, the transmissive liquid crystal display device is taken as an example, but the invention is not limited thereto, which can also be adapted to the other liquid crystal display devices such as a reflective type and a transflective type.

What is claimed is:

1. A substrate for a display device comprising:
a plurality of bus lines which is formed on a substrate as they intersect with each other through an insulating film;
a thin film transistor which is formed near a position at which the plurality of the bus lines intersect with each other;
a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode; and
a slit which is formed along the space at the first and/or second pixel electrode near the space.

2. The substrate for a display device according to claim 1, wherein the slit is extended almost in parallel with a direction in which the space is extended.

3. The substrate for a display device according to claim 1 further comprising:
a conductive layer which is disposed as it overlaps with the space,
wherein the slit is disposed near the conductive layer.

4. A substrate for a display device comprising:
a plurality of bus lines which is formed on a substrate as they intersect with each other through an insulating film;
a thin film transistor which is formed near a position at which the plurality of the bus lines intersect with each other;
a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode;
a conductive layer which is disposed as it is superimposed on the first or second pixel electrode; and
a slit which is formed along the conductive layer at the first and/or second pixel electrode near the conductive layer.

5. The substrate for a display device according to claim 4, wherein the slit is extended almost in parallel with a direction in which the conductive layer is extended.

6. The substrate for a display device according to claim 1, wherein a width of the slit is 4 μm or below.

7. A liquid crystal display device comprising:
a pair of substrates which are disposed as they face each other; and
liquid crystals which are sealed between the pair of the substrates,
wherein a substrate for a display device according to claim 1 is used for one of the pair of the substrates.

8. A substrate for a display device comprising:
a gate bus line which is formed on a substrate;
a drain bus line which is formed as it intersects with the gate bus line through an insulating film;
a storage capacitor bus line which is formed in parallel with the gate bus line;
a thin film transistor which is formed near a position at which the gate bus line and the drain bus line intersect with each other;
a pixel area provided with a first pixel electrode which is electrically connected to a source electrode of the thin film transistor, a second pixel electrode which is isolated from the first pixel electrode and connected to the source electrode through capacitance, and a space which isolates the first pixel electrode from the second pixel electrode; and
a lead electrode which is drawn from the storage capacitor bus line, and which forms superimposed capacitance between it and the second pixel electrode.

9. The substrate for a display device according to claim 8, wherein the lead electrode is extended as it overlaps with the space.

10. The substrate for a display device according to claim 8, wherein the lead electrode has a projection which is disposed as it overlaps with the second pixel electrode.

11. The substrate for a display device according to claim 8 further comprising:
a control capacitance electrode which is electrically connected to the source electrode, and which forms capacitance between it and the second pixel electrode; and
a second lead electrode which is drawn from the storage capacitor bus line and disposed as it overlaps with the control capacitance electrode, and which forms capacitance between it and the control capacitance electrode.

12. A liquid crystal display device comprising:
a pair of substrates which are disposed as they face each other; and
liquid crystals which are sealed between the pair of the substrates,
wherein a substrate for a display device according to claim 8 is used for one of the pair of the substrates.

13. The liquid crystal display device according to claim 12 further comprising:
a black matrix which is formed on one of the pair of the substrates, and which shields light around the pixel area,
wherein at least a part of the lead electrode is disposed in an area in which light is shielded by the black matrix.

14. The liquid crystal display device according to claim 12 further comprising:
an alignment regulating structure which is formed on at least one of the pair of the substrates, and which regulates alignment of the liquid crystals,
wherein at least a part of the lead electrode is disposed as it overlaps with the alignment regulating structure.
